(19) United States
(12) Patent Application Publication
(10) Pub. No.: US 2006/0101398 A1
(43) Pub. Date: May 11, 2006

(54) Program output management

(76) Inventors: Paul D. Schepers, Frisco, TX (US); Mark S. Evans, Plano, TX (US); Alan L. Gerhardt, Pittsburg, TX (US); Warner Lee Hines, Southlake, TX (US); Raymond M. Parker, Carrollton, TX (US); Robert L. Reeves, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/978,324

(22) Filed: Nov. 1, 2004

(51) Int. Cl. G06F 9/44; G06F 9/46

(52) U.S. Cl. 717/120; 718/100; 717/136

(57) ABSTRACT

Systems, methods, and devices are provided for program output routine management. One method embodiment provides for output routine management in a program. The method includes associating a first identifier with a first type of program output routine and associating a second identifier with a second type of program output routine. The method includes removing the first type of program output routine from the program before the program is deployed in a run time environment.

### INTRODUCTION

Computing devices, e.g., devices having processor and memory resources, are used as “network devices” to perform various roles and tasks within intelligent networks (INs). Computing devices include an operating system layer and an application program layer. The operating system layer includes a “kernel”. The kernel is a master control program that runs the computing device. The kernel provides functions such as task management, device management, and data management, among others. The application layer includes software programs (such as service logic programs (SLPs) used in telecommunication networks) that perform particular tasks. The application layer is referred to as being in “user space”, while the operating system layer can be referred to as “kernel space”. As used herein, “user space” implies a layer of code which is less privileged than the layer of code which is in the operating system layer or “kernel space”.

In addition to performing their intended tasks, application programs generally include routines, e.g., sets of computer executable instructions, to provide diagnostic information and debug information relating to the program (hereinafter referred to as “diagnostic” and “debug” routines). For example, the diagnostic and debug routines can execute to provide a status, e.g., health, of a given program. Such status information can be retrieved and analyzed by a system administrator while the program is being tested in a software development environment and/or when the program is used on a customer's system, e.g., in a run time environment. Some programs offer only two choices associated with the above mentioned diagnostic and debug routines, e.g. an “on” or “off” state. This means that the routines are either executed, i.e., “on”, to provide output information to a program user, or are not executed, i.e., “off”, so as not to provide output information to the program user. Whether or not these routines are set to the “on” state, the computer executable instructions which make up the routines remain part of the overall program. These computer executable instructions contribute to the overall size of a program, i.e., in lines of code, and in certain situations create a program file that is larger than desirable.

When developing and debugging an application much more diagnostic and/or debug information is required than can be handled when the program is deployed in a customer environment. When deployed, error information is still useful as output to the customer, but the diagnostic and debug information may not be needed and/or desired in the interest of the resource availability. That is, diagnostic and debugging routines, while useful during development, contribute to making programs even longer. Thus, diagnostic and debug routines, which may or may not be able to be used when the program is released in the customer's environment, consume valuable memory space.

### BRIEF DESCRIPTION OF THE DRAWINGS

FIG. 1 is a block diagram of a computer system suitable to implement embodiments of the invention.

FIG. 2A illustrates an example of a program module having a debug routine contained therein and compiled to have an identifier associated therewith according to embodiments of the present invention.

FIG. 2B illustrates an example embodiment of an identifier associated with a diagnostic and/or debug routine according to the teachings of the present invention.

FIG. 2C is a block diagram representing the operation of a program embodiment on a compiled object file.

FIG. 3A is a block diagram of a software development system suitable for creating program embodiments described herein.

FIG. 3B is a flowchart illustrating program embodiment development in a software development environment and program embodiment use in customer environment.

FIG. 4 is an example illustration of the interaction between a number of network functions and service functions which can include program embodiments as described herein.

### DETAILED DESCRIPTION

Embodiments of the present invention provide for output routine management in a program. One method embodiment includes associating a first identifier with a first type of program output routine, including diagnostic and debug routines, and associating a second identifier with a second type of program output routine. The first type of program output routine is removed from the program before the program is deployed in a run time environment. In various embodiments the program instructions execute to remove the diagnostic and debug routines from a compiled object file subsequent to performing diagnostic and debugging routines on the program.

Thus, embodiments include a program, such as an SLP executable on a computing device and/or network, where the program is devoid of all diagnostic and debug routines. According to embodiments, however, the program still retains the ability to output error messages, e.g., error message output routines are not removed.

In various embodiments, a program build tool is provided which includes access to processor and memory resources, detailed below. Computer executable instructions are provided, e.g., in the form of a shell script storable in the memory and executable by the processor, to remove all diagnostic and debug routines from a compiled object file. The shell script executes to identify and leave error message output routines in the object file which can then further be linked into an executable program for a customer's run time environment.

Computer System

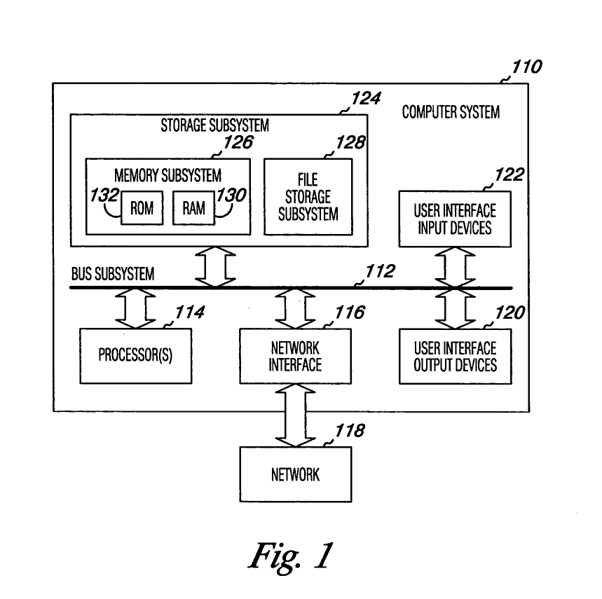

FIG. 1 is a block diagram of a computer system 110 suitable to implement embodiments of the invention. Computer system 110 includes at least one processor 114 which communicates with a number of other computing components via bus subsystem 112. These other computing components may include a storage subsystem 124 having a memory subsystem 126 and a file storage subsystem 128, user interface input devices 122, user interface output devices 120, and a network interface subsystem 116, to name a few, as the same will be appreciated by one of ordinary skill in the art. Network interface subsystem 116 provides an interface to outside networks, including an interface to network 118 (e.g., a local area network (LAN), wide area network (WAN), Internet, and/or wireless network, among others), and is coupled via network 118 to corresponding interface devices in other computer systems. Bus subsystem 112 provides a mechanism for letting the various components and subsystems of computer system 110 communicate with each other as intended. Program embodiments described herein can be executed on a computing device or system such as illustrated in FIG. 1.

Object Oriented Programming

Program embodiments discussed herein relate to object oriented programming. One type of popular programming is modular programming, e.g., object oriented programming, which breaks down the design of a program into individual components (modules) that can be programmed and tested independently. Object oriented programming is a form of modular programming with more formal rules that allow pieces of software to be reused and interchanged between programs. Object oriented programming concepts include encapsulation. Encapsulation is the creation of self-sufficient modules that contain the data and the processing (data structure and functions that manipulate that data). A program module can include one or more source files and, once compiled, one or more object files.

Example Module Embodiment

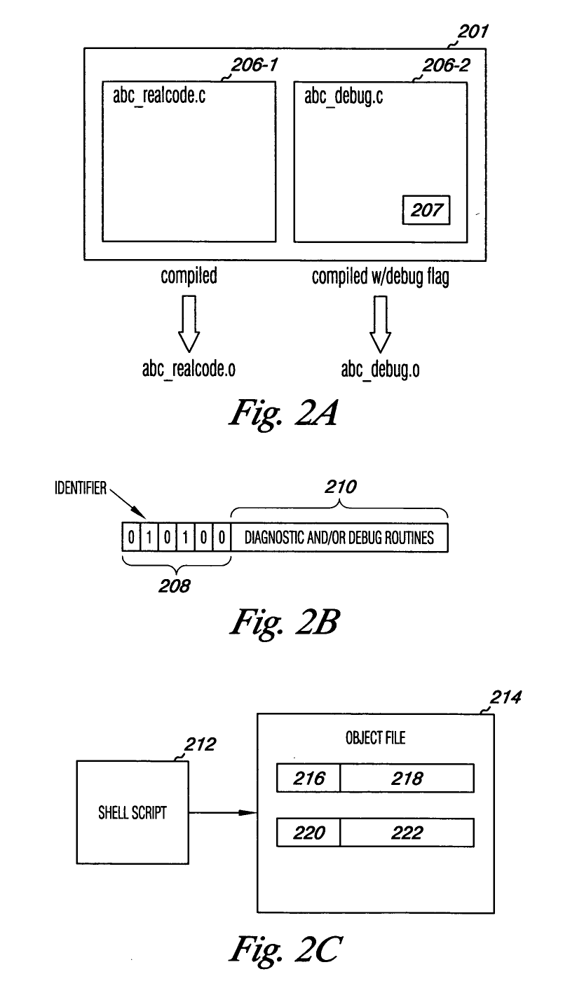

FIG. 2A illustrates an example program module 201 including one or more source files, e.g., 206-1 and 206-2. In the example embodiment of FIG. 2A, source file 206-2 includes debug routines and/or data as written by a software developer as part of creating a program. The module 201 is illustrated with only two source code files 206-1 and 206-2 for ease of illustration. However the program module can have more or fewer source code files associated with it. The source code file 206-1, labeled “abc_realcode.c”, contains the implementation of the module, as understood by one of ordinary skill in the art. Source code file 206-2, labeled “abc_debug.c”, represents a file which can be compiled with debug options and/or routines to be used in association with debugging the executable program.

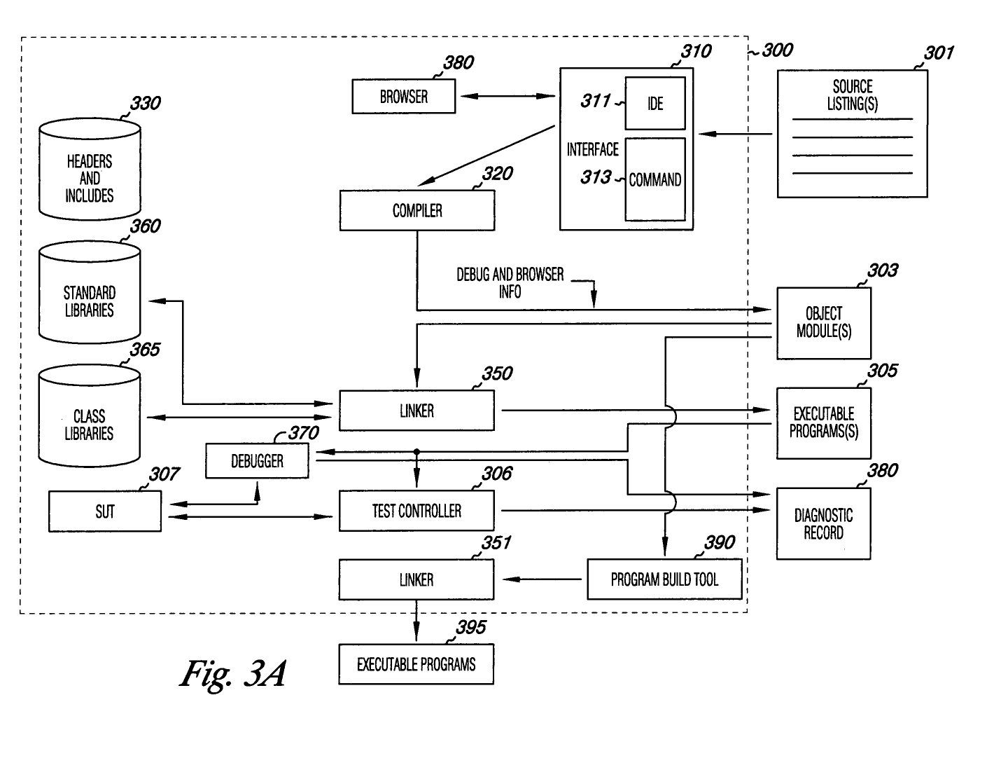

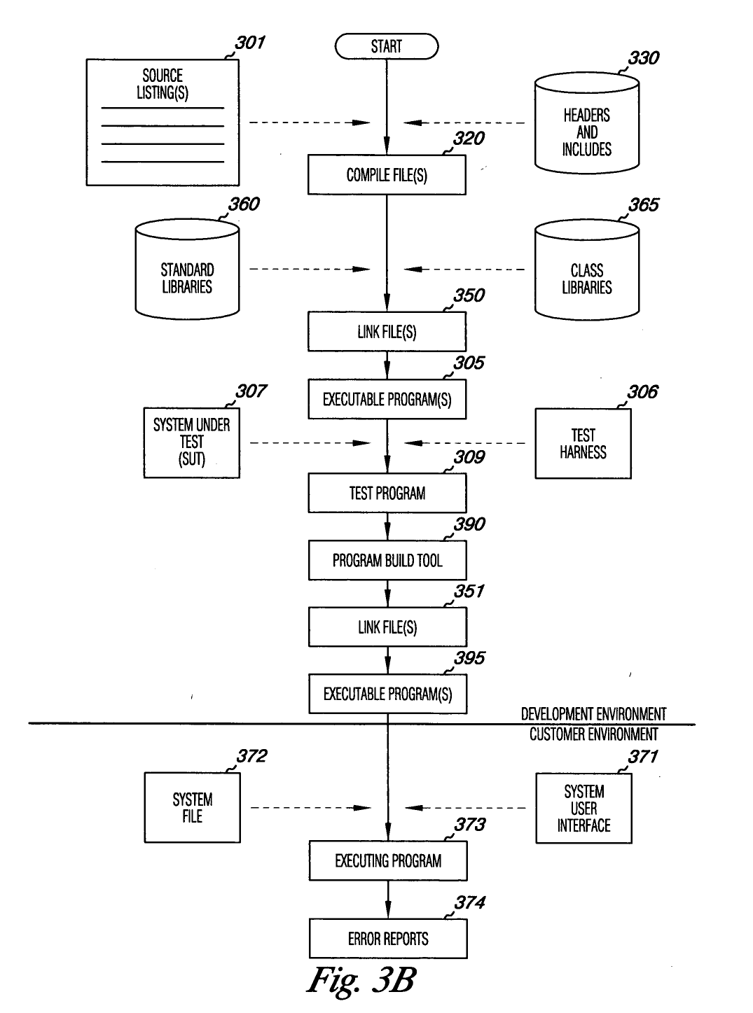

According to various embodiments described herein, as a software developer writes source code for the debug file of the program module she/he associates an identifier 207, e.g., a flag (also referred to herein as a tag), therewith. As shown in FIG. 2A, the source code files 206-1 and 206-2 are compiled to produce respective object files, shown as abc_realcode.o and abc_debug.o. The compile process is known and understood by one of ordinary skill in the art (also illustrated in FIGS. 3A and 3B). As shown in the embodiment of FIG. 2A, the identifier 207 associated with source code for the debug file 206-2 is compiled along with the debug source into a debug object file, e.g., abc_debug.o

Although the embodiment of FIG. 2A is illustrated in reference to a debug file, one of ordinary skill in the art will appreciate upon reading this disclosure that the software developer can associate one or more different and/or like identifiers with one or more similar and/or different source code files. That is, the developer can associate another type of identifier with source files containing error message routines (discussed more below). The developer can also associate one particular identifier with a number of different types of source files, e.g., all source files including debug routines, program diagnostic routines, etc. Embodiments are not limited to the debug example illustrated in FIG. 2A.

Example Embodiment for Identifier/Routine Association

FIG. 2B illustrates an embodiment of an identifier associated with a program output routine in a compiled object file. The example embodiment shown in FIG. 2B illustrates an identifier 208 as a predefined bit string associated with, e.g., connected to, a diagnostic and/or debug routine as can exist in a compiled object file for a given program. In FIG. 2B, the diagnostic and/or debug routine, which consists of computer executable instructions, is represented in block form for ease of illustration. The predefined bit string 208 serves as a flag for the diagnostic or debug routine within a compiled object file. As one of ordinary skill in the art will appreciate, the identifier 208 can be located as a header 208 (as shown in FIG. 2B) before a particular type of program output routine 210.

According to embodiments of the present invention, program instructions are provided which are storable in memory and executable by a processor (such as shown in FIG. 1) to search one or more compiled object files, e.g., “abc_debug.o” as shown in FIG. 2A, for a particular type of identifier such as identifier 208. As will be described in more detail in connection with FIGS. 3A and 3B, the program instructions can be provided as part of a program build tool in a software development environment and can be executed to search a compiled object file subsequent to compilation of the object file and subsequent to debug and test routines being performed on the object file but before the object file is linked into an executable program for deployment on a customer system.

As shown in FIG. 2C, in one embodiment the program instructions are provided to the build tool (discussed in FIG. 3A) in the form of a shell script 212. Embodiments, however, are not limited to program instructions provided in the form of a shell script. As one of ordinary skill in the art will appreciate, a shell script is a high level programming, or command, language that is interpreted rather that compiled ahead of time. That is, a shell script is interpreted, e.g., translated into machine language (binary code), as a program is running, rather than compiled into machine language ahead of time. JavaScript is one example of a scripting language.

As shown in FIG. 2C, the program instructions in shell script 212 execute to search a compiled object file 214 for one or more particular types of identifiers associated with various program output routines, e.g., error message program routines, diagnostic output routines, debug routines, etc. As used herein program output routines are intended to mean routines which execute to provide a program user with information relating to the health and/or status of a running, e.g., executing, program. As noted above, the various identifiers remain with such routines as they are compiled into object files. Thus, FIG. 2C illustrates a first identifier 216 associated with a first type of program output routine 218 and a second identifier 220 associated with a second type of program output routine 222 within the compiled object file 214.

As noted above, a number of like and/or different identifiers can be associated with various program output routines in the compiled object file 214. That is, the software developer can associate one or more different and/or like identifiers with one or more similar and/or different source code files. As these source code files are compiled, the identifiers (shown as 207 in FIG. 2A, 208 in FIG. 2B, 216 and 218 in FIG. 2C) remain with the particular routines to which they have been associated. In the example embodiment of FIG. 2C a developer has associated one type of identifier 216, e.g., as a predefined bit string, with a source file containing one particular type of program output routine and has associated another type of identifier 218 with a source file containing another particular type of program output routine.

According to this example embodiment, the first type of identifier 216 is a first predefined bit string which is different from the second type of identifier 220, also a predefined bit string. In various embodiments, the first type of identifier 216 is associated with all diagnostic and debugging program output routines, represented in block form by 218. Further, the second type of identifier is associated with all error message program output routines, represented in block form by 222. Diagnostic and/or debug program output routines, as well as error message program output routines, are generally known and well understood by one of ordinary skill in the art and are not described in more detail here so as not to obscure embodiments of this invention.

As noted above, in an embodiment, program instructions to operate on the compiled object file 214 can include instructions provided in the form of a shell script 212 (storable in memory and executable by a processor such as shown in FIG. 1). The shell script executes to search the compiled object file 214 for one or more various identifier types, e.g., 216 and 218. The shell script 212 is written by a software developer to identify all occurrences of a first identifier type 216 in the compiled object file 214. As one of ordinary skill in the art will appreciate upon reading this disclosure, the shell script can identify the occurrence one or more identifier type by comparing various predefined bit strings (connected to the various types of program output routines) to reference bit strings storable in a memory. The shell script is further executed to remove, that is to delete, all program output routines, e.g., 218, associated with the found first identifier types 216 in the compiled object file 214. One of ordinary skill in the art will appreciate the manner in which a shell script can execute to delete a routine from an object file. More discussion is not provided here so not to obscure the embodiments of the invention. Thus, in connection with the example given above, the shell script 212 will search and identify each occurrence in the compiled object file 214 of a first predefined bit string 216 which has been associated with all diagnostic or information program output routines written into the program by the software developer. Further, the shell script 212 will delete all the diagnostic or debug program output routines, associated with that first predefined bit string 216 from the compiled object file 214.

According to various embodiments, the shell script 212 is written by the software developer to identify all occurrences of one or more additional, different types of identifiers, e.g., second identifier type 220, associated various program output routines (e.g., a plurality of identifiers associated with a number of different output routines and not solely diagnostic and/or debug routines) in the compiled object file 214. In various embodiments, the shell script is executed to leave all program output routines, e.g., 222, associated with the found second identifier type 220 in the compiled object file 214. Thus, in connection with the example given above, the shell script 212 will search and identify each occurrence in the compiled object file 214 of a second predefined bit string 220 which has been associated with all error message program output routines, e.g., 222, as written into the program by the software developer. And, the shell script 212 will leave the error message program output routines, e.g., 222, in the compiled object file such that they can subsequently be linked (discussed in FIG. 3A) into a completed executable programs for use in a customers run time environment (discussed in FIG. 3B). Thus, an executable program produced according to these embodiments for the customer's run time environment will be devoid of all diagnostic and debug program output routines, but still retain all error message program output routines. Such a program will reduce the amount of memory resources consumed by the executable program in the customer's run time environment as compared to an executable program having diagnostic and debug routines still present therein.

Example Program Development and Use Embodiments

FIG. 3A is a block diagram of a software development system 300 suitable for creating program embodiments described herein. FIG. 3A is discussed in reference to object oriented programming. As noted earlier, C++ and Java are examples of object oriented programming languages.

FIG. 3A is provided to illustrate the development environment in which a program developer can write source code 301 to associate an identifier with one or more various program output routines, e.g., to associate a first predefined bit string with all diagnostic and debug routines and to associate a second predefined bit string with all error message routines. Using the development environment illustrated in FIG. 3A, the program developer can additionally create program instructions, e.g., in the form of a shell script, which can be provided to a program build tool (described below), having access to processor and memory resources (such as shown in FIG. 1). The shell script can be executed to search and identify one or more different identifier types. The shell script then executes to remove particular program output routines associated with certain identifier types from a compiled object file subsequent to performing debug and testing routines on the object files (i.e., after the object files have undergone an analysis in the development environment, also referred to as a “program analysis routine” and/or “analyze step” in the compilation process).

Once the developer has written source code 301 to associate one or more identifier types with one or more types of program output routines, the source code 301 is provided to a compiler 320 and a linker utility 350 via an interface 310. The interface 310 can include both command-line driven 313 and Integrated Development Environment (IDE) 311 interfaces as the same are known and understood in the art. From the source code 301 and header and includes files 330 (also known and understood by one of ordinary skill in the art) the compiler 320 “compiles” or generates object modules 303, each containing one or more object files. A linker 350 next “links” or combines the object modules 303, each having one or more object files, with standard libraries 360 (e.g., graphics, I/O routines, startup code, and the like) to generate executable program(s) 305. As shown in FIG. 3A, the development system 300 can provide class libraries 365, e.g., C++ libraries, in addition to standard libraries 360.

As shown in FIG. 3A, an executable program(s) 305 can be connected to a test controller 306 and a system under test (SUT) 307 in order to test program(s) 305. As programs are developed they are tested under a workload, e.g., a SUT, to ensure that the programs will function as intended. The executable programs 305 can be provided to a debugging module 370 for eliminating errors in the source code listings 301. The debugging module 370 can execute a set of software instructions in cooperation with a SUT 307 and test controller 306 to produce a diagnostic record 380 for an executable program 305. As used herein, performing these debug and testing routines on the executable program 305 is referred to collectively as performing a “program analysis routine” and/or “analyze step” in the compilation process.

As the reader will appreciate, once the developer has performed such debug and testing routines, she/he can make further edits to the program in order to ameliorate issues, e.g. glitches, bugs, invalid states, etc., found by testing and debugging the executable program 305. Once the developer is satisfied with the condition, e.g., performance, of the program, embodiments of the invention are further employed to remove various routines, e.g., diagnostic and debug routines, from the executable program that is released to the customer.

To achieve the same, and as illustrated in FIG. 3A, the object modules 303 (e.g., program modules containing compiled object files such as 214 in FIG. 2C) are provided to a program build tool 390. The program build tool has access to processor and memory resources such as illustrated in FIG. 1. According to various embodiments, the program build tool 390 executes instructions, e.g., a shell script as the same has been described above, to identify and remove diagnostic and debug routines which are tagged as such (as the same has been described above). After removing all of the diagnostic and debug routines from compiled object files in the object module(s) 303, the object modules are once again passed to a linker 351 which operates in the same manner as linker 350 to produce executable programs 395. According to the embodiments described herein, the executable programs 395 will have been tested and debugged and then stripped of all diagnostic and debugging routines for deployment in the customer's run time environment. These executable programs 395 are smaller in size, having had the diagnostic and debug routines removed therefrom, than are their counterparts 305 which have not had diagnostic and debug routines removed.

FIG. 3B is a flowchart illustrating the continuance of a programs life cycle from the development environment in FIG. 3A to actual use in the customer's run time environment. The development environment portion of FIG. 3B mirrors the discussion which was provided in FIG. 3A. FIG. 3B exemplifies that executable programs (e.g., 395 in FIG. 3A) can be loaded onto a device to sell to a customer once the development environment process is complete. Likewise, the product can be shipped on disk to a customer and the customer can load the executable programs onto their system.

FIG. 3B is useful for illustrating that although diagnostic and debug routines have been removed from the executable programs, these programs still retain the ability to output error messages. As illustrated in FIG. 3B, a system user, e.g., system administrator, can interact with an executing program 373 running on the customer system using such tools as a system user interface 371 and a customer “system file” 372. In this example, the executing program 373 includes the executable program 395 which in the above development environment has had all of its debug and diagnostic routines removed after the analyze step in the compilation process. However, according to the embodiments described above, error message routines have been purposefully left in the executing program 373. Thus, as shown in FIG. 3B, when an error occurs in the executing program 373, an associated error message routine will execute to output an error message to the user, illustrated by error reports 374.

Example Communications Network

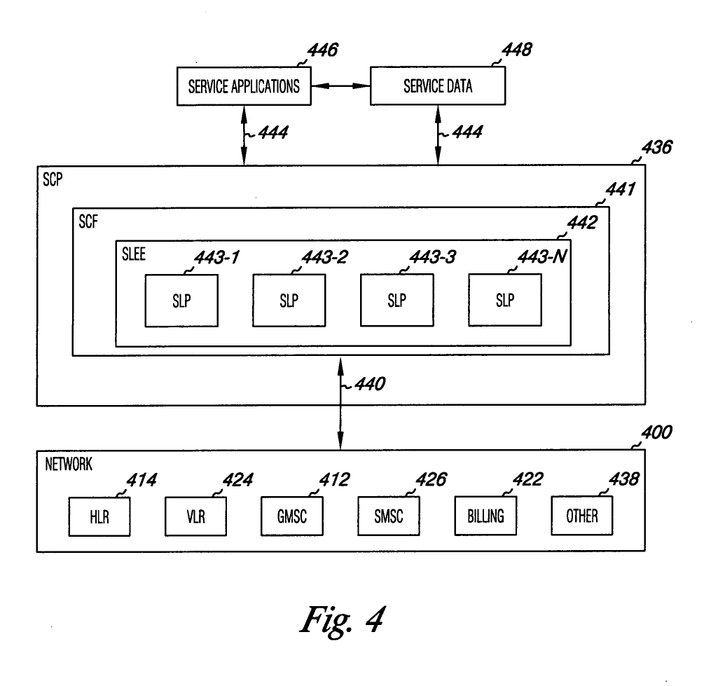

FIG. 4 is an example illustration a system network, e.g., a wireless telecommunications network, showing the interaction between a number of network functions and service functions which can include program embodiments (exemplified here as service logic programs (SLPs)) having an identifier associated with a diagnostic and/or debug routine as the same have been described herein. FIG. 4 is an example illustration of the interaction between a number of network functions and service functions. In FIG. 4, a number of functions within network 400 interact with a number of services provided through a service control point (SCP) 436. Network functions, e.g., home location register (HLR) 414, visitor location register (VLR) 424, gateway mobile switching center/controller (GMSC) 412, service mobile switching center/controller (SMSC) 426, billing 422, and other functions 438, can communicate requests for services including requests for data, communications between devices or networks, and the like, which will employ SLPs. These requests for services and the responses to such requests can be provided by a number of different protocols, such as intelligent network application part (INAP), mobile application part (MAP), customized applications for mobile network enhanced logic (CAMEL), and capability set (CS) protocols, etc. The requests are directed to the SCP 436 via transaction capabilities application part (TCAP) messages 440 to create a session, e.g., message exchange, with an SLP 443-1, 443-2, 443-3, . . . 443-N within a SLEE 442. The designator “N” is used to illustrate that a number of such SLPs can be created. The SLEE is an environment in which SLP instances are created. The SLEE 442 can provide the role of a service control function (SCF) 441 on the SCP 436.

A given SLP may connect via a communication link 444 with one of a number of service applications 446 and/or service data 448 to fulfill the requests for services. In some embodiments, service applications can be of various types and can be grouped based upon the type of services they provide. For example, Parlay service applications, as the same will be will be understood by one of ordinary skill in the art, or other such service application groups can be used.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for output routine management in a program, comprising:
associating a first identifier with a first type of program output routine;
associating a second identifier with a second type of program output routine; and
removing the first type of program output routine from the program before the program is deployed in a run time environment.

2. The method of claim 1, wherein the first type of program output routine is selected from the group of:
a diagnostic output routine; and
a debug output routine; and
wherein the second type of program output routine is an error output routine.

3. The method of claim 1, further including:
performing a program analysis routine on the program as part of a compilation process; and
subsequent to the program analysis routine, searching an object file of the program for the first identifier.

4. The method of claim 3, further including removing the first type of program output routine associated with the first identifier from the object file.

5. The method of claim 4, further including using a program to search and remove the first type of program output routine.

6. The method of claim 1, further including associating the first identifier with the first type of program output routine as part of developing a service logic program.

7. A method for output routine management in a service logic program (SLP), comprising:
associating a first identifier with a debug output routine and a diagnostic output routine for the SLP;
associating a second identifier with error output routine for the SLP;
performing a program analysis routine on the SLP as part of a compilation process; and
subsequent to the program analysis routine, searching an object file of the SLP for the first identifier.

8. The method of claim 7, further including removing the diagnostic output routine and the debug output routine associated with the first identifier from the object file before the program is deployed in a run time environment.

9. The method of claim 8, further including using a program to search and remove the diagnostic output routine and the debug output routine associated with the first identifier.

10. The method of claim 9, wherein associating a first identifier with diagnostic output routine and debug output routine includes associating a first tag comprised of a first predefined bit string, and associating a second identifier with error output routine includes associating a second tag comprised of a second predefined bit string.

11. The method of claim 10, wherein using the program to search and remove the diagnostic output routine and the debug output routine associated with the first identifier includes comparing first and second identifiers, located in the object file, to reference bit strings storable in a memory.

12. The method of claim 11, further including leaving error output routine associated with the second identifier in the program to be deployed in the run time environment.

13. The method of claim 7, further including using object oriented programming to associate the first identifier with diagnostic output routines and debug output routines and to associate the second identifier with error output routines.

14. A computer readable medium having computer executable instructions to cause a device to perform a method, comprising:
searching an object file of a service logic program (SLP) for a first identifier associated with a first type of program output routine; and
when the first identifier is found, removing the first type of program output routine associated therewith from the object file before the program is deployed in a run time environment.

15. The medium of claim 14, further including searching the object file subsequent to performing a program analysis routine on the SLP.

16. The medium of claim 14, further including using a program to search the object file and remove the first type of program output routine.

17. The medium of claim 16, wherein the first type of program output routine is selected from the group of:
a diagnostic output routine; and
a debug output routine; and
wherein the method further includes using the program to detect a second identifier associated with second type of program output routine in the object file of the SLP.

18. The medium of claim 17, wherein the second type of program output routine includes error output routine, and the method further includes leaving the error output routine in the SLP to be deployed in the run time environment.

19. The medium of claim 14, further including using a program to search for various identifiers associated with various types of program output routines in the object file, and using the program to compare found identifiers to reference identifiers in a memory.

20. The medium of claim 19, wherein the various identifiers are tags including predefined bit strings, and the method further includes using a shell script to search for various tags and to compare found tags to predefined bit strings storable in the memory.

21. A program build tool, comprising:
a processor;
a memory coupled to the processor; and
computer executable instructions storable in the memory and executable by the processor to:
subsequent to performing an analysis routine on a program, search an object file of the program for a first identifier associated with a first type of program output routine; and
when the first identifier is found, remove the first type of program output routine associated therewith from the object file before the program is deployed in a run time environment.

22. The tool of claim 21, wherein the program is a service logic program (SLP).

23. The tool of claim 21, wherein the computer executable instructions include a program to search the object file and remove the first type of program output routine.

24. The tool of claim 23, wherein the first type of program output routine is selected from the group of:
a diagnostic output routine; and
a debug output routine; and
wherein the program can execute to detect a second identifier associated with second type of program output routine in the object file of the SLP.

25. The tool of claim 24, wherein the second type of program output routine includes error output routine, and wherein the program executes to keep the error output routine in the SLP for use in the run time environment.

26. The tool of claim 21, wherein the computer executable instructions can execute to identify the first identifier by comparing various predefined bit strings, associated with various types of program output routines, to reference bit strings storable in a memory.

27. A network device, comprising:
a processor; and
a memory coupled to the processor, the memory including:
a service logic program (SLP), wherein the SLP is devoid of all diagnostic information instruction routines and all debug instruction routines; and
wherein the SLP includes error message instruction routines.

28. The device of claim 27, wherein the SLP includes only two levels associated with output routines, the two levels being an “on” state and an “off” state.

29. The device of claim 27, wherein the SLP can execute error message instruction routines to output error messages when program output routines are enabled.

30. The device of claim 27, wherein the device is a service control point providing a multiple service logic execution environment (multi-SLEE) to perform a service control function (SCF).

31. The device of claim 30, wherein the SLP executes as part of the SCF.

32. A program development tool, comprising:
a processor; and
a memory coupled to the processor, and
means for removing diagnostic and debug output routines, without affecting error output routines, from a program prior to deploying the program in a run time environment.

33. The tool of claim 32, the program is a service logic program.

34. The tool of claim 32, wherein the means includes program instructions which execute to search an object file of the program for an identifier associated with diagnostic and debug output routines subsequent to performing an analysis routine on a program.

35. The tool of claim 32, wherein the means includes executing a shell script written to identify and remove diagnostic and debug output routines, without affecting error output routines, from an object file of the program.

36. A communication network, comprising:
a gateway mobile switching center (GMSC); and
a service control point (SCP) coupled to the GMSC, wherein the SCP includes a processor and a memory coupled to the processor, the memory including:
a service logic program (SLP), wherein the SLP is devoid of all diagnostic routines and all debug routines; and
wherein the SLP includes error message instruction routines.
